(19) United States
(12) Patent Application Publication
(10) Pub. No.: US 2026/0054274 A1
(43) Pub. Date: Feb. 26, 2026

(54) Equipment for Purifying Dust-containing Gas with Positive Pressure

(71) Applicant: Suzhou University of Science and Technology, Suzhou (CN)

(72) Inventors: Xing ZHANG, Suzhou (CN); Yubin CHI, Suzhou (CN); Zhigang WANG, Suzhou (CN); Wenjian TAO, Suzhou (CN)

(73) Assignee: Suzhou University of Science and Technology, Suzhou (CN)

(21) Appl. No.: 19/377,711

(22) Filed: Nov. 3, 2025

Related U.S. Application Data
(63) Continuation of application No. PCT/CN2024/093634, filed on May 16, 2024.

(51) Int. Cl. B04C 5/185; B01D 45/16; B01D 46/24; B01D 50/20; B04C 5/04; B04C 5/103; B04C 9/00

(52) U.S. Cl. CPC B04C 5/185; B01D 45/16; B01D 46/2403; B01D 50/20; B04C 5/04; B04C 5/103; B04C 9/00; B04C 2009/002

(57) ABSTRACT

An equipment for purifying dust-containing gas includes: a frame; a cyclone device disposed at one side of the frame and having a gas inlet; a settling chamber disposed to communicate with the cyclone device; a purifying chamber; a collection and extrusion device, the settling chamber and the purifying chamber, and used to extrude and recycle a dust collected therein. The dust-containing gas enters the cyclone device from the gas inlet, and after at least a portion of dust is removed from the gas by the cyclone device, in the settling chamber, at least a portion of the dust is settled down with collision under an action of inertial force carried by the dust-containing gas, and then, the gas enters the purifying chamber to be purified, and then exits from an outlet of the purifying chamber.

### CROSS-REFERENCE TO RELATED APPLICATION

This application is a continuation of International Patent Application No. PCT/CN2024/093634 filed on May 16, 2024, the disclosure of which is hereby incorporated by reference in its entirety.

### BACKGROUND

As an important facility in air pollution prevention and control, a gas dust removal equipment is mainly used for purifying harmful substances contained in the gas such as dust, powders of dust, large particles of dust, lint dust in the production and living sites. By providing the gas dust removal equipment in the production and living sites, it can effectively purify the air, to reduce or even eliminate harmful pollution sources, particularly the gas or air pollution caused by fine particle material, so as to reduce the probability of intake of the harmful substances and protect health of laborers and residents. The gas dust removal equipment can also reduce the residual rate of the air pollution substances in the air by effectively absorbing the toxic and harmful substance in the air, so as to further reduce the pollution degree of the air and improve the environment of the production and living.

However, the existing gas dust removal equipment generally adopts a dust removal mode with negative pressure. Compared with a dust removal mode with positive pressure, although the dust removal mode with negative pressure has advantages such as high dust removal efficiency and stable operation, under the dust removal mode with negative pressure, when the dust-containing gas enters the gas dust removal equipment, an abrupt decrease of the dust removal efficiency is caused by uneven flow distribution, unreasonable flow channel layout in the gas dust removal equipment. Meanwhile, in the production processes of some industries, it is necessary to adopt transporting the airflow with the positive pressure, especially in the situations that the airflow contains particles, lint dusts and the like. And it is urgent for the control of such pollution substance, to develop and design an equipment for purifying dust-containing gas with positive pressure.

Currently, the usual equipment for purifying dust-containing gas with positive pressure generally suffers from issues, such as severe wear of the equipment, uneven pressure control, poor sealing and so on. Moreover, there is a potential risk of explosion of powers of dust when dealing with the metal powder dust.

In view of the above, it is necessary to improve the airflow channel layout inside the equipment for purifying dust-containing gas with positive pressure, enhance the flow distribution within the dust removal equipment, and improve the dust removal efficiency.

### SUMMARY

In order to solve or partially solve issues in some implementations described above, the aim of the disclosure is to provide an equipment for purifying dust-containing gas with positive pressure, which adopts an air supply mode with positive pressure, improves the airflow distribution inside the equipment for purifying dust-containing gas with positive pressure and increases the dust removal efficiency.

The disclosure of this application relates to the field of air pollution control technology, and in particular to an equipment for purifying dust-containing gas with positive pressure.

According to one respect of the disclosure, an equipment for purifying dust-containing gas with positive pressure is provided, wherein the equipment for purifying dust-containing gas with positive pressure includes:
a frame, wherein other main parts of the equipment for purifying dust-containing gas with positive pressure are disposed on the frame;
a cyclone device, which is disposed at one side of the frame, and is arranged with a gas inlet;
a settling chamber, which is disposed to communicate with the cyclone device;
a purifying chamber, which is disposed at the other side of the frame, and is communicated with the settling chamber; and
a collection and extrusion device, which is disposed at a bottom end of the frame, and is communicated with a lower end of at least one of the cyclone device, the settling chamber and the purifying chamber, and is used to extrude and recycle a dust collected therein.

In some embodiments, a tilted deflector plate is disposed at a lower edge of the gas inlet.

Further, in some embodiments, a tilt angle of the tilted deflector plate is the same as a lead angle of a helical line of a helical face of the cyclone device.

In some embodiments, a gas inlet end is disposed at one side of the settling chamber, and the gas inlet end is set at a position of a ⅔ height of a total height of the one side of the settling chamber.

In some embodiments, the settling chamber has a baffle plate, and the baffle plate is located at an opposite side of the gas inlet end.

Further, in some embodiments, a gas outlet end is formed at a gap which is located between the baffle plate and a bottom of the settling chamber, and a cross-section area of the gas outlet end is set to be 2-4 times, preferably 3 times, as large as a cross-section area of the lower end of the settling chamber. A lower end of the settling chamber serves as a connection part between the settling chamber and the collection and extrusion device.

In some embodiments, the purifying chamber includes a filter cylinder assembly, which is disposed at an upper part of the purifying chamber, and is located in a region between an outlet of the purifying chamber and a place where the dust-containing gas enters the purifying chamber.

In some embodiments, the collection and extrusion device includes a housing, which is shaped like an elongated cylinder, and is disposed at the bottom end of the frame, wherein the lower end of at least one of the cyclone device, the settling chamber and the purifying chamber is communicated with the housing.

Further, in some embodiments, the housing includes blades therein, which are arranged in a longitudinal direction of the housing, and each have an outer edge abutting against an inner wall of the housing; and a drive part is disposed at an end of the housing in the longitudinal direction thereof, and drives the blades to rotate.

Furthermore, in further embodiments, the housing has a conical outlet, which is disposed on the other end of the housing in the longitudinal direction thereof, and a cone bottom of the conical outlet is communicated with the housing; and the collection and extrusion device also has a collection part, the collection part is communicated with a cone top of the conical outlet.

The equipment for purifying dust-containing gas with positive pressure provided in accordance with the embodiments of the disclosure has at least one of the following advantages or a part of one advantage thereof:
the air supply mode with positive pressure is adopted, instead of using the air supply mode with negative pressure, in order to improve the airflow distribution inside the dust removal equipment and increase the efficiency of dust removal;
the tilted deflector plate is arranged at the lower edge of the gas inlet of the cyclone device, and the tilt angle of the tilted deflector plate is the same as the lead angle of the helical line of the helical face of the cyclone device, so that reentrainment of dust can be avoided, and the more even distribution of the interior airflow is beneficial for settling of the dust and lint;
the gas inlet end is disposed at the position of the ⅔ height of the total height of the one side of the settling chamber, and the baffle plate is disposed at the opposite side of the gas inlet end, so that the dust-containing gas collides with the baffle plate after entering the settling chamber, and the airflow direction o is abruptly changed, at least a portion of dust is separated from the dust-containing gas under the action of inertial force carried by the dust-containing gas, so as to achieve a partial dust removal effect;
the gas outlet end is disposed at the gap which is located between the baffle plate and the bottom of the settling chamber, and the cross-section area of the gas outlet end is 2-4 times as large as the cross-section area of the lower end of the settling chamber, such that when the dust-containing gas exits via the gas outlet end and enters the purifying chamber, the dust-containing gas undergoes dramatical reduction of the flow velocity when passing through the filter cylinder assembly due to the setting of the cross-section area of the gas outlet end, so as to avoid the situation that the flow velocity is excessive high to lead the dust and lint flying around, and improve the dust removal effect of the settling chamber;
by arranging the outer edge of each blade of the collection and extrusion device abutting against the inner wall of the housing, and in combination with the rotated blades, a function of closing a wind valve can be achieved, in order to avoid the crossflowing;
the dust is extruded by the conical outlet, so that the space needed for the dust collection will decrease, which is more convenient to store the dust.

It should be understood that the above general description and the detailed descriptions below are exemplary and explanatory only and do not limit the disclosure.

### BRIEF DESCRIPTION OF THE DRAWINGS

These and other aspects, and advantages of the disclosure will be more apparent and understandable from description of the embodiments of the disclosure in conjunction with the drawings below, wherein:

FIG. 1 is a front view of an equipment for purifying dust-containing gas with positive pressure in accordance with an embodiment of the disclosure;

FIG. 2 is a schematical cross-section view of a structure of the equipment for purifying dust-containing gas with positive pressure as shown in FIG. 1;

FIG. 3 is a schematic structural view of a tilted deflector plate provided at a gas inlet of a cyclone device as shown in FIG. 1;

FIG. 4 is a schematic structural perspective view of another equipment for purifying dust-containing gas with positive pressure in accordance with an embodiment of the disclosure;

FIG. 5 is a schematic structural view of a settling chamber as shown in FIG. 1;

FIG. 6 is a schematic structural view of a baffle plate and a gas outlet end of the settling chamber as shown in FIG. 5;

FIG. 7 is a schematic structural view of a purifying chamber as shown in FIG. 1;

FIG. 8 is a partially enlarged view of the purifying chamber as shown in FIG. 7; and

FIG. 9 is a schematic structural view of a collection and extrusion device as shown in FIG. 1.

### DETAILED DESCRIPTION

Hereinafter, the features of the disclosure will be further set forth by specific embodiments. The description of the embodiments of the disclosure with reference to the drawings intends to explain the general concept of the disclosure and should not be understood as a limitation to the disclosure.

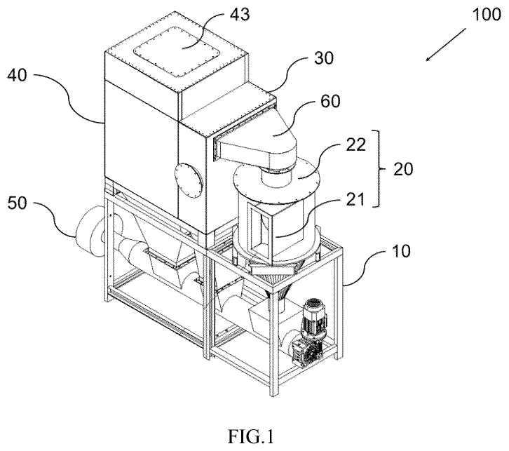

Referring to FIG. 1, in an embodiment of the disclosure, an equipment 100 for purifying dust-containing with positive pressure is provided, which can be applied for broader fields of dust particles, lint dust removal and so on.

The equipment 100 for purifying dust-containing gas with positive pressure includes four major parts consisting of a frame 10, a cyclone device 20, a settling chamber 30, a purifying chamber 40, and so on. Before the dust-containing gas enters the equipment 100 for purifying dust-containing gas with positive pressure, a positive pressure of the dust-containing gas is generated by an external air supply device, that is, the dust-containing gas is delivered into the cyclone device 20 by the external air supply device.

Specifically, the frame 10 is used to support other major parts of the equipment 100 for purifying dust-containing gas with positive pressure. The dust-containing gas with positive pressure enters the cyclone device 20 via a gas inlet end 21, and at least a portion of dust of the dust-containing gas is separated from the dust-containing gas under the action of a centrifugal force generated when the dust-containing gas flows through the cyclone device 20, therefore, the purified dust-containing gas is created.

The dust-containing gas purified by the cyclone device 20 enters the settling chamber 30 though a connection pipe 60, and at least a portion of dust is settled down with collision under an action of inertial force carried by the dust-containing gas.

The dust-containing gas after being settled down in the settling chamber 30 enters the purifying chamber 40 and is purified, and the purified gas flows out from an outlet 43 of the purifying chamber 40. By a mutual coordination of three dust removal devices consisting of the cyclone device 20, the settling chamber 30, the purifying chamber 40, a problem of a decrease of purifying efficiency caused by an airflow fluctuation can be overcome effectively, and a stable performance of dust removal operation can be improved, and furthermore the dust removal efficiency of the equipment 100 for purifying dust-containing gas with positive pressure can be increased. For the specific structure design, refer to the detailed description below, please.

It is to be noted, a shortcoming of an air supply mode with negative pressure is that, due to a low pressure intensity area formed in the interior contrast to the exterior, under an action of different pressure, an external air enters the equipment 100 of purifying dust-containing gas with positive pressure via the outlet 43, which results in an uneven distribution of the interior airflow and leads to the decrease of the dust removal efficiency.

In the present embodiment, the equipment 100 for purifying dust-containing gas with positive pressure adopts an air supply mode with positive pressure, instead of the air supply mode with negative pressure, to improve the airflow distribution inside the dust removal equipment and increase the dust removal efficiency.

The equipment 100 for purifying dust-containing gas with positive pressure also includes a collection and extrusion device 50 for collecting and extruding the dust at a bottom end thereof. It can be understood that, the collection and extrusion device 50 can be set to communicate with a lower end of at least one of the cyclone device 20, the settling chamber 30 and the purifying chamber 40, to extrude and recycle the dust collected therein.

The cyclone device 20, the settling chamber 30, the purifying chamber 40 and the collection and extrusion device 50 are completely communicated inside the equipment 100 for purifying dust-containing gas with positive pressure, which can effectively avoid a problem of uneven pressure control; besides, the cyclone device 20, the settling chamber 30, the purifying chamber 40 and the collection and extrusion device 50 are closely connected inside the equipment 100 for purifying dust-containing gas with positive pressure, which avoids a problem of poor sealing as an integral equipment.

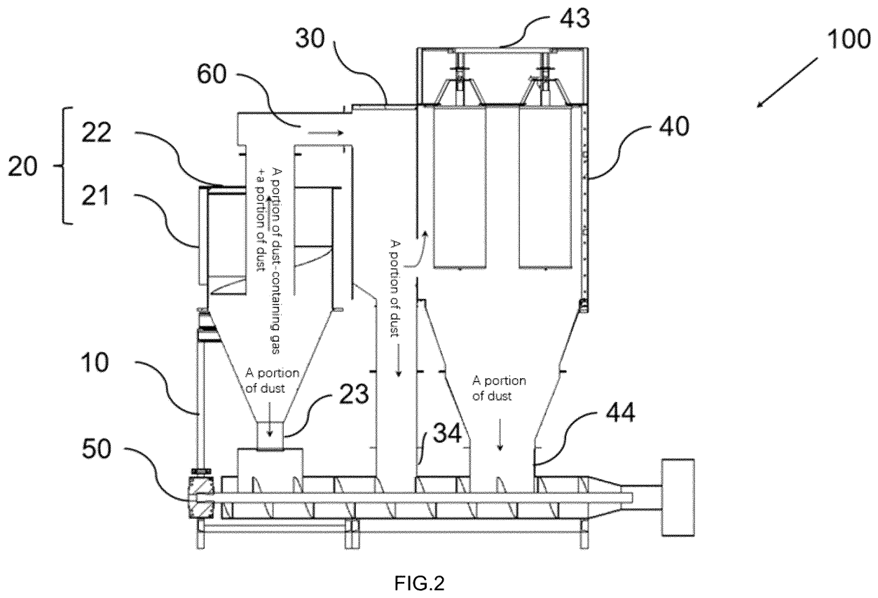

Referring to FIG. 2, specifically, the cyclone device 20 includes the gas inlet 21 and a centrifugal cyclone part 22. A gas inlet direction of the gas inlet 21, i.e. a flow direction of the dust-containing gas, is perpendicular to a direction of a rotation axis of the centrifugal cyclone part 22. The dust-containing gas enter the cyclone device 20 via the gas inlet 21, and at least of a portion of the dust of the dust-containing gas is removed by the centrifugal cyclone part 22 of the cyclone device 20 by means of the positive pressure carried by the dust-containing gas. In an example, the gas flow velocity at the gas inlet 21 is 3-6 m/s.

The lower end 23 of the cyclone device 20 is communicated with the collection and extrusion device 50, and under an action of the positive pressure carried by the dust-containing gas, at least of a portion of the dust of the dust-containing gas is separated from the dust-containing gas under an action of the centrifugal force generated when the dust-containing gas flows through the centrifugal cyclone part 22 of the cyclone device 20, and enters the collection and extrusion device 50 via the lower end 23 of the cyclone device 20.

In another embodiment, referring to FIG. 2, the lower end 34 of the settling chamber 30 is also set to communicate with the collection and extrusion device 50, and at least a portion of the dust of the dust-containing gas is separated from the dust-containing gas under the action of the inertia force carried by the dust-containing gas, and enters the collection and extrusion device 50 via the lower end 34 of the settling chamber 30.

As shown in FIG. 2, the dust-containing gas enters the settling chamber 30 from one side of the settling chamber 3 through a connection pipe 60 of the cyclone device 200. In an alternative embodiment, referring to FIG. 1, an overall cross-section area of a connecting port of the connection pipe 60 with the cyclone device 20 is in size smaller than an overall cross-section area of a connecting port of the connection pipe 60 with a gas inlet end 31 of the settling chamber 30. For example, the cross-section area of the connection pipe 60 on the side of the settling chamber 30 is in size larger than the cross-section area of the connection pipe 60 on the side of the cyclone device 20, referring to FIG. 1 for illustration. And the flow velocity of the dust-containing gas through the connection pipe 60 gradually decreases, which effectively reduces turbulence and is beneficial for further improving dust removal effect after entering the settling chamber 30.

In a further embodiment, the lower end 44 of the settling chamber 40 is communicated with the collection and extrusion device 50. The dust-containing gas enters the settling chamber 40 and is purified, and then at least of a portion of the dust is separated from the dust-containing gas, and enters the collection and extrusion device 50 by the lower end 44 of the purifying chamber 40.

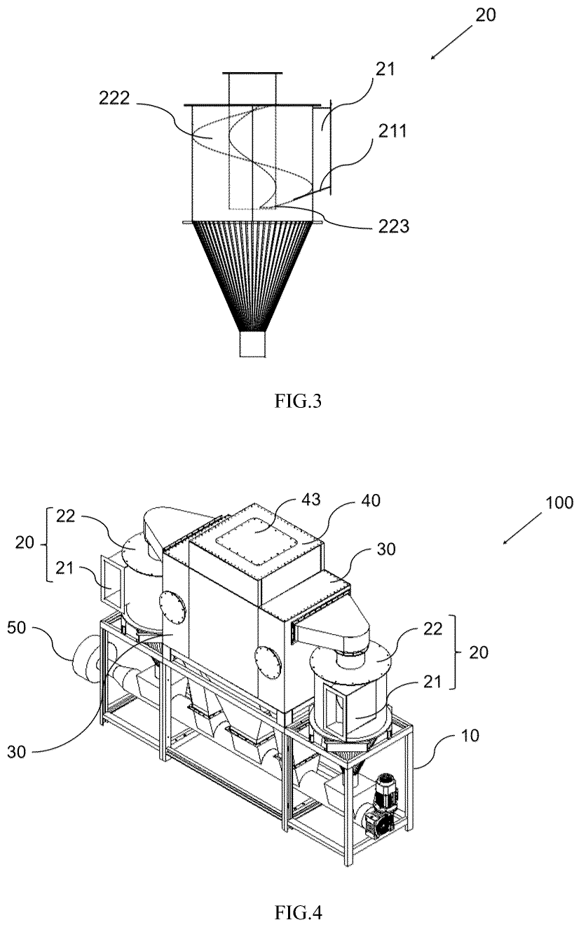

Referring to FIG. 3, in one embodiment described, a tilted deflector plate 211 is disposed at a lower edge of the gas inlet 21, and a tilt angle of the tilted deflector plate 211 is the same as a lead angle of a helical line 223 of a helical face 222 of the cyclone device 20. In this way, the dust-containing gas is avoided from an influence of the turbulence which could otherwise lead part of the removed dust to be re-entrained, and generates a secondary dusting, so as to impact dust removal effect.

It can be known that from the simulation analysis of a flow field inside the cyclone device 20, the airflow distribution inside the cyclone device 20 is more even after disposing the tilted deflector plate, which is beneficial for settling the dust and the lint dust.

Referring to FIG. 4, in an alternative embodiment, the equipment 100 for purifying dust-containing gas with positive pressure can be configured for intake gas from one side or one end, and of course, also can be configured for intake gas from both sides or two ends, or multiple ends. Those skilled in the art can set it as needed.

The following explanation is made by taking a configuration of using intake gas from two opposite ends as an example. Both of the settling chambers 30 are disposed respectively on both sides of the purifying chamber 40, e.g., they are disposed symmetrically with respect to the middle of the purifying chamber 40; and the cyclone devices 20 are respectively disposed to communicate to the settling chamber 30 at the same side, and one common purifying chamber 40 is disposed in the middle of the equipment 100 for purifying dust-containing gas with positive pressure. In this way, a spare space is sufficiently utilized and corresponding parts are omitted out, thereby increasing the dust removal efficiency.

Please referring to FIG. 5, the settling chamber 30 is disposed to have a rectangular parallelepiped structure, and of course, it can also be disposed as any other appropriate shape structure. The gas inlet end 31 is located at the one side of the settling chamber 30. Preferably, the gas inlet end 31 is set at a position of a ⅔h height of a total height h of the one side of the settling chamber 30. The dust-containing gas enters the settling chamber 30 via the gas inlet end 31, and exits from the settling chamber 30 via a gas outlet end 33.

In one embodiment described, the settling chamber 30 is also arranged with a baffle plate 32, which is set at an opposite side of the gas inlet end 31. For example, the baffle plate 32 is set on a top of the settling chamber 30 and is extended downward. The gas outlet end 33 is formed at the gap which is located between the baffle plate 32 and the inside of the settling chamber 30. As shown in FIG. 5, the gas outlet end 33 is set to be opposite to the gas inlet end 31 by the baffle plate 32, that is, the gas inlet end 31 is set at a top left corner of the settling chamber 30, and the gas outlet end 33 is set at a bottom right corner of the settling chamber 30. In this way, after entering the settling chamber 30 from the gas inlet end 31, the dust-containing gas generally flows from top to bottom, and a flow path of the dust-containing gas to the gas outlet end 33 is longest, which therefore is an optimal option based on the dust settling by the gravity effect and the flow path, and achieves the best settling effect.

In one embodiment, the gas flow velocity in the settling chamber 30 is 7-12 m/s.

It can be known that from the simulation analysis of the flow field inside the settling chamber 30, after entering the settling chamber 30 via the gas inlet end 31, the dust-containing gas collides with the baffle plate 32, the airflow direction changes abruptly, and at least a portion of the dust is separated from the dust-containing gas under the action of inertial force carried by the dust-containing gas.

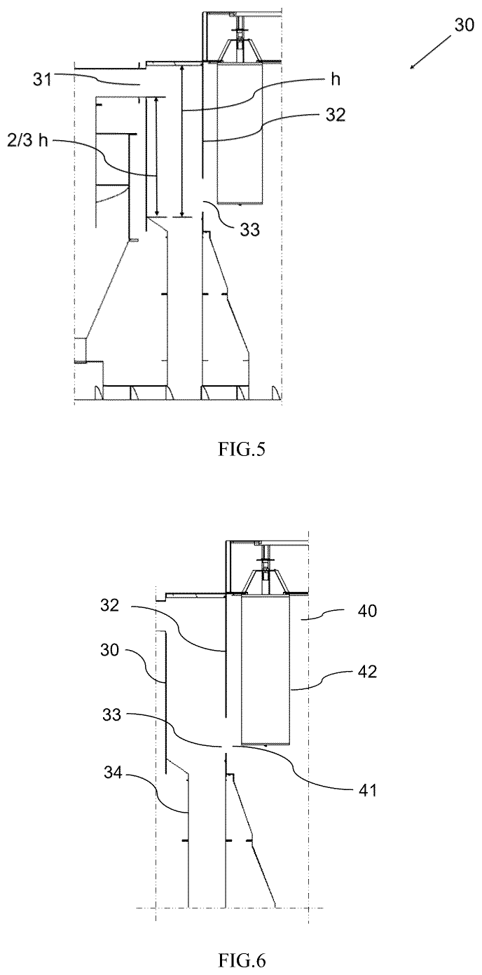

Referring to FIG. 6, a cross-section area of the gas outlet end 33 is 2-4 times, preferably 3 times, as large as a cross-section area of a bottom end 34 of the settling chamber 30, wherein the bottom end 34 of the settling chamber 30 serves as a connection section between the settling chamber 30 and the collection and extrusion device 50. It can be known that from the simulation analysis of the flow field between the purifying chamber 40 and the settling chamber 30, when the dust-containing gas exits via the gas outlet end 33 and enters the purifying chamber 40, because the cross-section area of the gas outlet end 33 is 2-4 times as large as the cross-section area of the bottom end 34 of the settling chamber 30, the flow velocity of the dust-containing gas decreases dramatically as the dust-containing gas flows through a filter cylinder assembly 42 of the purifying chamber 40, and furthermore flying of dust particles and lint dust is avoided due to the too big flow velocity, improving dust removal effect of the settling chamber.

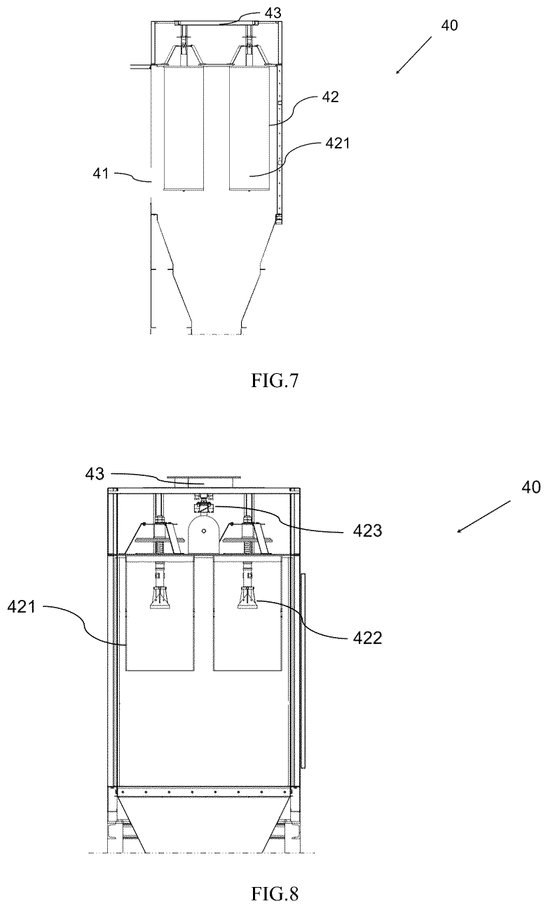

Please referring to FIG. 7, in an embodiment, the purifying chamber 40 includes three parts and others, and the three parts include: a gas inlet hole 41, which can be the same one as the gas outlet end 33, or can be configured to be separate, as long as it is cmmunicated with the outlet gas end 33; the filter cylinder assembly 42; and the outlet 43. For example, two filter cylinder assemblies 42 can be set in the purifying chamber 40, and they are disposed in parallel on a top of the purifying chamber 40 and connected fixedly to an end of the purifying chamber 40 close to the outlet 43.

Specifically, each filter cylinder assembly 42 is disposed on an upper part of the purifying chamber 40, located in a region inside the purifying chamber 40 between the outlet 43 and the gas inlet hole 41. Each filter cylinder assembly 42 also includes a filter cylinder 421, on which multiple filter holes are disposed so that it is convenience for the dust-containing gas to pass through. When the dust-containing gas enters into the purifying chamber 40, it passes through the filter cylinder assembly 42, then exits from the purifying chamber 40 via the outlet 43.

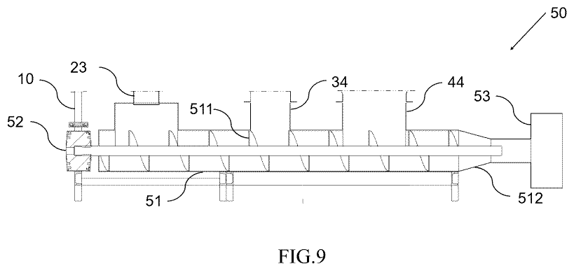

Referring to FIG. 8, further, in an embodiment, the filter cylinder assembly 42 includes the filter cylinder 421, a pulse generator 422, a pulse valve 423, a gas tank and an electric control system. According to the practical working condition, the filter cylinder 421 of different specification can be selected, and a size of the gas tank can be adjusted to save the cost.

When the dust-containing gas passes through the filter cylinder 421, at least a portion of the dust is blocked outside, and then the filtered gas passes the filter cylinder 421 and exits via the outlet 43; meanwhile, the gas tank contains compressed air, the gas tank is connected with the pulse generator 422 by the pulse valve 423, the pulse valve 423 is automatically controlled to open or close by the electric control system based on the change of the pressure value inside the filter cylinder assembly 42 (referring to FIG. 7) detected by a pressure sensor. When the pulse valve 423 is opened, the compressed air in the gas tank is sprayed out by the pulse generator 422 from the gas tank through the pulse valve 423, and is sprayed into an interior of the filter cylinder 421 so as to clean the dust attached on a surface of the filter cylinder assembly 42.

In an embodiment, referring to FIG. 9, the lower end 44 of the purifying chamber 40 is communicated with the collection and extrusion device 50. The dust-containing gas enters the purifying chamber 40, and passes through the filter cylinder assembly 42, and at least a portion of the dust is separated from the dust-containing gas, and is blocked outside the filter cylinder assembly 42, and one part of the separated dust directly drops into the collection and extrusion device 50, another part of the separated dust is attached on the outside wall of the filter cylinder 421. The electric control system automatically controls the pulse valve 423 to open according to the pressure value change detected by the pressure sensor, and the air in the gas tank is discharged from the pulse valve 423, and the filter cylinder 42 is cleaned through using spraying in an opposite direction by pulse, such that the dust falls off and then drops into the collection and extrusion device 50.

Referring to FIG. 9, in an embodiment, the collection and extrusion device 50 includes three parts consisting of a housing 51, a drive part 52 and a collection part 53 and others.

Specifically, the housing 51 has an elongated cylinder shape, and of course, also can have any other expected shape. The housing 51 is disposed on a bottom end of the frame 10, wherein the lower end of at least one of the cyclone device 20, the settling chamber 30 and the purifying chamber 40 is communicated with the housing 51.

Further, in an embodiment, the housing 51 is communicated with the lower end 23 of the cyclone device 20, and at least a portion of the dust of the dust-containing gas enters the housing 51 via the lower end 23; the housing 51 is communicated with the lower end 34 of the settling chamber 30, and at least a portion of the dust of the dust-containing gas enters the housing 51 via the lower end 34; and the housing 51 is communicated with the lower end 44 of the purifying chamber 40, at least a portion of the dust of the dust-containing gas enters the housing 51 via the lower end 44.

In an embodiment, the housing 51 includes blades 511 therein, which are arranged in a longitudinal direction of the housing 51, and each have an outer edge abutting against an inner wall of the housing 511. The housing cooperates with the blades 511 to function as wind closing valve, to avoid the crossflow during a downstream transport process.

In an embodiment, the drive part 52 is disposed at an end of the housing 51 in the longitudinal direction thereof, and drives the blades 511 to rotate. The housing 51 has a conical outlet 512, which is located at the other end of the housing 51 in the longitudinal direction thereof. A cone bottom of the conical outlet 512 is communicated with the housing 51, and a cone top of the conical outlet 512 is communicated with the collection part 53. Under the push action when the blades 511 are driven by the drive part 52 to rotate, the dust is constantly accumulated toward the conical outlet 512, and finally is extruded at the conical outlet 512 and enters the collection part 53, which is beneficial to reduce an occupied space for dust collection, and is more convenient for dust storage.

In operation, the dust is delivered out by rotation of blades 511, and the conical outlet 512 is set to have a preset conical degree, e.g., 10-30 degrees, so that the dust is extruded at this place, in this way, the space for dust collection is reduced, and thereby the dust is stored after being extruded. Besides, the rotation of the blades 511 also play a role of the wind closing valve so that there is no crossflowing during the downstream transport process.

The working principle of the equipment 100 for purifying dust-containing gas with positive pressure provided by the embodiments is briefly described as follows:

The dust-containing gas is delivered into the gas inlet 21 by the positive pressure. At first, the dust-containing gas enters the cyclone device 20 from the gas inlet 21, and by the centrifugal cyclone part 22 of the cyclone device 20, the dust-containing gas is rotated at high velocity along the periphery, and thereby the relatively large centrifugal force is generated, and a portion of the heavy/big dust falls into the collection and extrusion device 50, and another portion of the dust-containing gas enters the settling chamber 30; and under an action of the collision of the baffle plate 32, the relatively heavy/big dust collides and is settled down under the gravity effect, then falls into the collection and extrusion device 50, another portion of the dust-containing waste gas enters the purifying device 40; the dust is intercepted on an exterior wall of the filer cylinder assembly 42 under an interception effect of the filer cylinder assembly 42, then through spraying in an opposite direction by pulse, the dust falls into the collection and extrusion device 50; and in the end the cleaned gas is discharged from the outlet 43.

The equipment for purifying dust-containing gas with positive pressure provided in accordance with the multiple embodiments of the disclosure has at least one of the following advantages or a part of one advantage thereof:
the air supply mode with positive pressure is adopted, instead of using the air supply mode with negative pressure, in order to improve the airflow distribution in the dust removal equipment and increase the efficiency of dust removal;
the tilted deflector plate is arranged at the lower edge of the gas inlet of the cyclone device, and the tilt angle of the tilted deflector plate is the same as the lead angle of the helical line of the helical face of the cyclone device, so that reentrainment of dust can be avoided, and the distribution of the interior airflow becomes more even, which is beneficial for settling of the dust and lint;
the gas inlet end is disposed at the position of the ⅔ height of the total height of the one side of the settling chamber, and the baffle plate is disposed at the opposite side of the gas inlet end, wherein the dust-containing gas collides with the baffle plate after entering the settling chamber, and the flow direction of the dust-containing gas is abruptly changed, at least a portion of dust is separated from the dust-containing gas under the action of inertial force carried by the dust-containing gas, so as to achieve a partial dust removal effect;
the gas outlet end is disposed at the gap which is located between the baffle plate and the bottom of the settling chamber, the cross-section area of the gas outlet end is 2-4 times as large as the cross-section area of the lower end of the settling chamber, so that when the dust-containing gas enters the purifying chamber via the gas outlet end, and the dust-containing gas undergoes dramatical reduction of the flow velocity when passing through the filter cylinder due to the setting of the cross-section area of the gas outlet end, so as to avoid the situation that the flow velocity is excessive high to lead the dust and lint flying around, and improve the dust removal effect of the settling chamber;
by arranging the outer edge of each blade of the collection and extrusion device abutting against the inner wall of the housing, and in combination with the rotated blades, a function of wind closing valve can be achieved, avoiding the crossflowing;

the dust is extruded by the conical outlet, so that the space needed for the dust collection will decrease, which is convenient to store the dust.

The forgoing embodiments are only preferred embodiments of the disclosure, and the scope of the disclosure is not limited to the foregoing embodiments. Without departing apart from the principle and spirit of a general inventive concept of the disclosure, those skilled in the art will understand that the changes can be made to these embodiments and shall be deemed as included in the scope of the disclosure. The scope of the disclosure is defined by the claims and their equivalents.

What is claimed is:

1. An equipment for purifying dust-containing gas with positive pressure, comprising a frame, wherein the equipment for purifying dust-containing gas with positive pressure further comprises:
a cyclone device, which is disposed at one side of the frame, and is arranged with a gas inlet;
a settling chamber, which is disposed to communicate with the cyclone device;
a purifying chamber, which is disposed at an other side of the frame, and is communicated with the settling chamber; and
a collection and extrusion device, which is disposed at a bottom end of the frame, and is communicated with a lower end of at least one of the cyclone device, the settling chamber and the purifying chamber, and is used to extrude and recycle a dust collected therein.

2. The equipment for purifying dust-containing gas with positive pressure in accordance with claim 1, wherein
a tilted deflector plate is disposed at a lower edge of the gas inlet.

3. The equipment for purifying dust-containing gas with positive pressure in accordance with claim 2, wherein
a tilted angle of the tilted deflector plate is a same as a lead angle of a helical line of a helical face of the cyclone device.

4. The equipment for purifying dust-containing gas with positive pressure in accordance with claim 1, wherein
a gas inlet end is disposed at one side of the settling chamber, and the gas inlet end is located at a position of a two-thirds height of a total height of the one side of the settling chamber.

5. The equipment for purifying dust-containing gas with positive pressure in accordance with claim 4, wherein
the settling chamber has a baffle plate, and the baffle plate is located at an opposite side of the gas inlet end.

6. The equipment for purifying dust-containing gas with positive pressure in accordance with claim 5, wherein
a gas outlet end is formed at a gap which is located between the baffle plate and a bottom of the settling chamber, and a cross-section area of the gas outlet end is set to be 2-4 times as large as a cross-section area of the lower end of the settling chamber.

7. The equipment for purifying dust-containing gas with positive pressure in accordance with claim 1, wherein
the purifying chamber comprises a filter cylinder assembly, which is disposed at an upper part of the purifying chamber, and is located in a region between an outlet of the purifying chamber and a place where the dust-containing gas enters the purifying chamber.

8. The equipment for purifying dust-containing gas with positive pressure in accordance with claim 1, wherein
the collection and extrusion device comprises a housing, which is shaped like an elongated cylinder, and is disposed at the bottom end of the frame, wherein the lower end of at least one of the cyclone device, the settling chamber and the purifying chamber is communicated with the housing.

9. The equipment for purifying dust-containing gas with positive pressure in accordance with claim 8, wherein
the housing has blades therein, which are arranged in a longitudinal direction of the housing, and each have an outer edge abutting against an inner wall of the housing; and a drive part is disposed at an end of the housing in the longitudinal direction thereof, and drives the blades to rotate.

10. The equipment for purifying dust-containing gas with positive pressure in accordance with claim 9, wherein
the housing has a conical outlet, which is disposed on an other end of the housing in the longitudinal direction thereof, and a cone bottom of the conical outlet is communicated with the housing; and
the collection and extrusion device also has a collection part, which is communicated with a cone top of the conical outlet.
